(19) United States
(12) Patent Application Publication
(10) Pub. No.: US 2012/0139834 A1
(43) Pub. Date: Jun. 7, 2012

(54) APPARATUS AND METHOD FOR CONTROLLING OBJECTS

(75) Inventors: Seung Ju HAN, Seoul (KR); John Ah Park, Seoul (KR); Hyung Kew Lee, Gunpo-si (KR)

(73) Assignee: SAMSUNG ELECTRONICS CO., LTD., Suwon-si (KR)

(21) Appl. No.: 13/252,528

(22) Filed: Oct. 4, 2011

(30) Foreign Application Priority Data
Dec. 1, 2010 (KR) 10-2010-0121289

(51) Int. Cl. G06F 3/033

(52) U.S. Cl. 345/157

(57) ABSTRACT

An apparatus and method for controlling an object are provided. The object control apparatus includes a detection module to detect deformation of a flexible display device, a storage module to store a first table including feature information regarding deformation of the flexible display device, and pattern information regarding deformation patterns of the flexible display device, the pattern information matching the feature information, and a control module to generate the feature information from deformation information regarding the detected deformation, to extract the pattern information corresponding to the generated feature information from the first table, and control at least one of a pointer and an object based on the extracted pattern information.

### CROSS-REFERENCE TO RELATED APPLICATIONS

This application claims the benefit of Korean Patent Application No. 10-2010-0121289, filed on Dec. 1, 2010, in the Korean Intellectual Property Office, the disclosure of which is incorporated herein by reference.

### BACKGROUND

1. Field

One or more example embodiments of the following description relate to an apparatus and method for controlling an object, and more particularly, to an apparatus and method for controlling an object using a flexible display device.

2. Description of the Related Art

Flexible display devices are currently the object of much research and development. When the flexible display device is ultimately put into practical use, video advertisements may be continuously displayed through large area displays mounted on large walls of department stores, curved ceilings of tunnels, and the like. Also, people may be able to walk with various displays attached to their clothing.

The flexible display device refers to a display device having characteristics of a conventional display device while having thickness of not greater than several centimeters, like a sheet of paper. The flexible display device may be curved, bent, or rolled by being made of a thin and flexible substrate. Since the flexible display device is lightweight, thin, shock-resistant, and flexible in comparison to the conventional hard display device, the flexible display device is expected to be widely applied to lifestyle-related products.

In particular, there is an increasing demand for a method of intuitively controlling a pointer or an object, using the flexible display device directly as an input device.

### SUMMARY

The foregoing and/or other aspects are achieved by providing an apparatus for controlling an object, including a detection module to detect deformation of a flexible display device, a storage module to store a first table including feature information regarding deformation of the flexible display device, and pattern information regarding deformation patterns of the flexible display device, the pattern information matching the feature information, and a control module to generate the feature information from deformation information regarding the detected deformation, to extract the pattern information corresponding to the generated feature information from the first table, and control at least one of a pointer and an object based on the extracted pattern information.

The foregoing and/or other aspects are achieved by providing a method for controlling an object including detecting deformation of a flexible display device, generating feature information regarding deformation of the flexible display device, from deformation information regarding the detected deformation, extracting pattern information matching the generated feature information, the pattern information regarding deformation patterns of the flexible display device, from a table including the feature information and the pattern information, and controlling at least one of a pointer and an object based on the extracted pattern information.

The foregoing and/or other aspects are achieved by providing a flexible display device including a processor, a detection module to detect deformation of the flexible display device, and a control module to generate an execution operation of the flexible display device in accordance with the deformation of the flexible display device detected by the detection module.

The control module controls an operation of the flexible display device based on the generated execution operation. The controlled operation includes controlling at least one of a pointer and an object displayed by the flexible display device.

The flexible display device also includes a storage module to store a first table including pattern information regarding deformation patterns of the flexible display device, and the control module generates feature information based on the deformation of the flexible display device detected by the detection module, extracts pattern information from the first table corresponding to the generated feature information, and controls the operation of the flexible display device based on the extracted pattern information.

The flexible display device alternatively includes a storage module to store a first table including pattern information regarding deformation patterns of the flexible display device, and the control module generates feature information based on the deformation of the flexible display device detected by the detection module, extracts pattern information from the first table corresponding to the generated feature information, and controls the at least one of the pointer and the object based on the extracted pattern information.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a diagram showing a structure of an object control apparatus according to example embodiments;

FIGS. 2 through 11 illustrate diagrams showing pattern information regarding deformation of a flexible display device according to example embodiments; and

FIG. 12 illustrates a flowchart showing an object control method according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

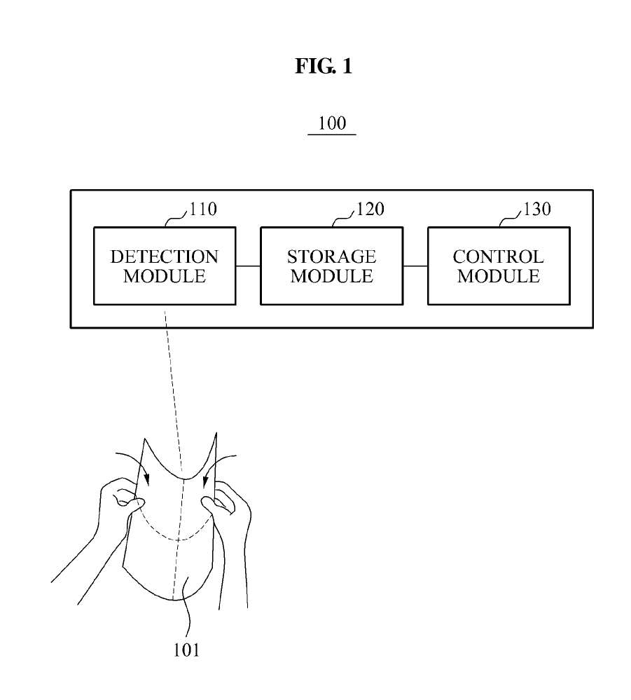

FIG. 1 illustrates a diagram showing a structure of an object control apparatus 100 according to example embodiments

Referring to FIG. 1, the object control apparatus 100 may include, for example, a detection module 110, a storage module 120, and a control module 130.

When a user inputs a control signal by deforming a flexible display device 101, the object control apparatus 100 may control at least one of a pointer and an object, for example, a pointer or an object displayed by the flexible display device. That is, the user may use the flexible display device 101 as an input device for controlling the pointer or the object. The object control apparatus 100 may detect deformation of the flexible display device 101 performed by the user, and control the pointer or the object according to a detection signal.

The object control apparatus 100 according to the example embodiments may be inserted in or included within the flexible display device 101 in the form of a module.

The detection module 110 may detect deformation of the flexible display device 101. The user may input a predetermined control signal by deforming the flexible display device 101. For example, the user may deform the flexible display device 101 by folding, bending, or rolling the flexible display device 101 in a predetermined direction. The detection module 110 may detect the deformation of the flexible display device 101. For example, the detection module 110 may detect an amount of the deformation or a type of the deformation of the flexible display device 101 by the user.

The flexible display device 101 may include a plurality of strain gauges arranged in the form of a grid. The plurality of strain gauges may include, for example, any one of thin metal film strain gauges, semiconductor strain gauges, and optical strain gauges.

The storage module 120 may store a first table including feature information regarding deformation of the flexible display device 101, and pattern information regarding deformation patterns of the deformation 101. In an embodiment, the pattern information may match the feature information.

The first table according to example embodiments may store the feature information and the pattern information. Here, the feature information and the pattern information may match each other.

The feature information may be related to deformation of the flexible display device 101.

According to example embodiments, the feature information may include at least one of a deformation direction, a quantity of deformation axes, a curvature of a deformation axis, a position of the deformation axis, and a movement of the deformation axis, all of which are related to the deformation of the flexible display device 101.

The control module 130 may generate the feature information from deformation information regarding the detected deformation. Here, the deformation information may include information about at least one of a deformation position, the deformation direction, and a deformation force, all of which are related to the deformation of the flexible display device 101. Depending on embodiments, the deformation position may be indicated by a planar coordinate value with respect to a planar surface of the flexible display device 101.

That is, the control module 130 may generate the feature information regarding the deformation direction, the quantity of the deformation axes, the curvature of the deformation axis, the position of the deformation axis, and the movement of the deformation axis, from the deformation information regarding the position, direction, and force of the deformation of the flexible display device 101.

For example, when the user folds the flexible display device 101 inward, the control module 130 may generate the feature information denoting features of the deformation of the flexible display device 101, from the detected deformation information. The deformation information may include ‘middle’ as the deformation position, ‘inward’ as the deformation direction, ‘10’ as the deformation force. The feature information may include ‘inward’ as the deformation direction, ‘1’ as the quantity of deformation axes from the deformation position, ‘5’ as the curvature of the deformation from the deformation force, ‘vertically middle’ as the position of the deformation axis from the deformation position, and ‘none’ as the movement of the deformation axis.

The control module 130 may extract the pattern information matching the feature information generated from the first table. In addition, the control module 130 may control at least one of the pointer and the object, based on the extracted pattern information.

The storage module 120 may further store a second table including the pattern information, and an execution operation matching the pattern information. In an embodiment, the execution operation is related to at least one of the pointer and the object.

Here, the control module 130 may process the execution operation matching the extracted pattern information, by referring to the second table.

For example, out of at least one pattern regarding the deformation of the flexible display device 101, a first pattern may match an execution operation for enlarging the object. Accordingly, when the deformation of the flexible display device 101 performed by the user is detected as matching the first pattern, the control module 130 may enlarge the object.

Table 1 is a matching table listing deformation types of the flexible display device 101 and the execution operations related to at least one of the pointer and the object, corresponding to the deformation types. Table 1 is suggested as an example embodiment, without limiting the present invention.

TABLE 1

| Deformation patterns of flexible display | |
|---|---|
| device | Execution operations |
| Fully bend backwards | Power On |
| Fully bend forward | Power Off |
| Bend backwards | Enlarge |
| Bend forward | Reduce |
| Diagonally bend right upper corner | Next execution operation |
| Diagonally bend left upper corner | Previous execution operation |
| Bend forward while moving bent portion | Move selected object |
| from left to right or from right to left | |

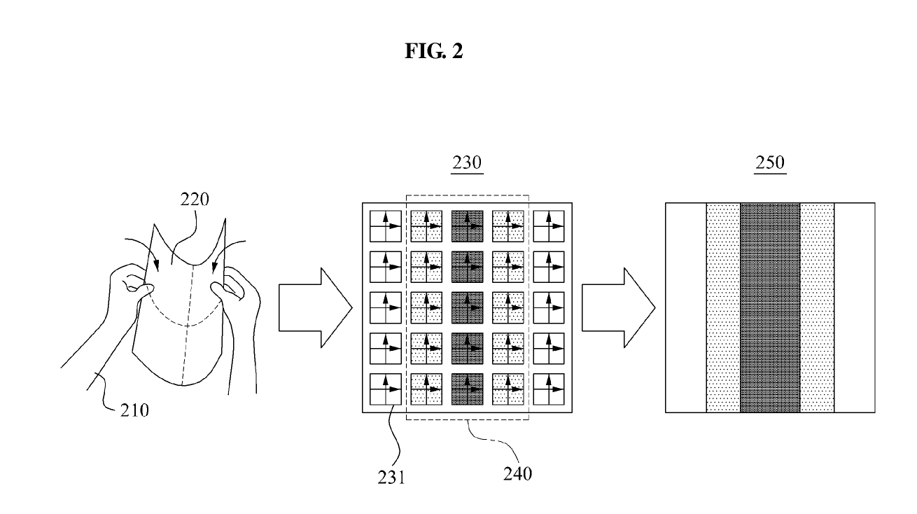

FIGS. 2 through 11 illustrate diagrams showing pattern information regarding deformation of a flexible display device 220 according to example embodiments.

Referring to FIG. 2, a user 210 may deform the flexible display device 220.

Here, the flexible display device 220 may include a plurality of strain gauges 231 arranged in the form of a grid.

The plurality of strain gauges 231 may detect deformation of a surface of the flexible display device 220 to which the plurality of strain gauges 231 are attached. Specifically, the plurality of strain gauges 231 may be configured in a grid arrangement to detect deformation of a planar surface of the flexible display device 220, the planar surface including two axes.

Referring to an inner structure 230 of the flexible display device 220, a strain gauge 240 of the plurality of strain gauges 231 of the flexible display device 220 may detect deformation of the flexible display device 220 and may generate an electrical signal corresponding to the detected deformation. A detection module of an object control apparatus according to example embodiments may detect the deformation of the flexible display device 220 by receiving the electrical signal generated by the strain gauge 240. In an embodiment, the detection module may receive electrical signals generated by one or more strain gauges of the plurality of strain gauges 231.

In the object control apparatus, the control module may generate feature information using deformation information, and extract pattern information 250 matching the feature information by referring to a storage module. That is, when the user 210 deforms the flexible display device 220 in a particular way, the control module of the object control apparatus may generate the pattern information 250 denoting deformation patterns of the flexible display device 220, from the deformation of the flexible display device 220.

In addition, the control module 130 may control the pointer or the object based on the pattern information 250.

The control module 130 may generate information on the deformation direction as the feature information related to the deformation of the flexible display device, from the deformation information detected by the detection module. For example, the control module may generate the information on the deformation direction from the deformation information regarding a deformation coordinate value, a deformation force, and the like.

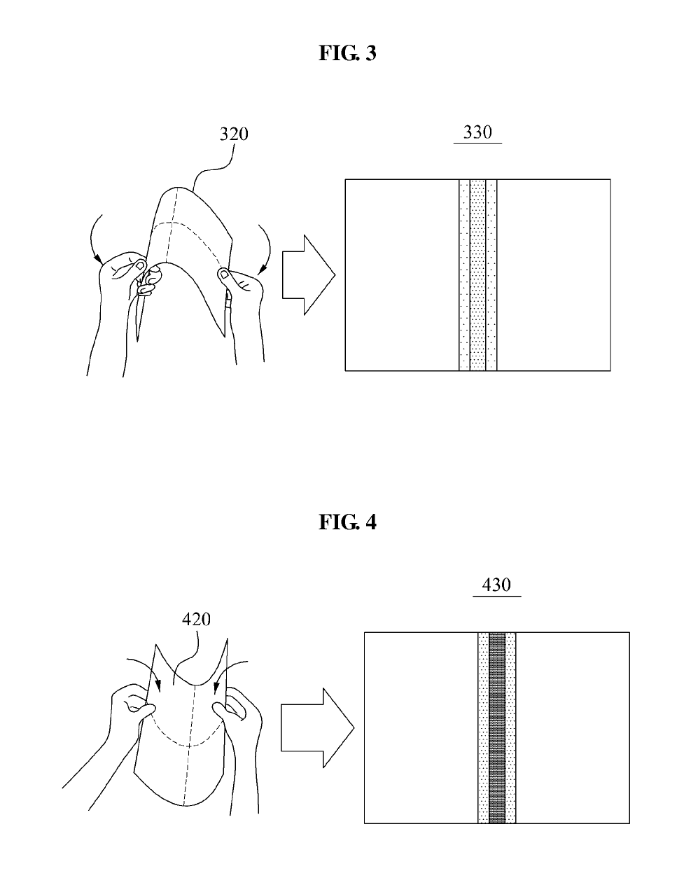

Referring to FIG. 3, when the user deforms a flexible display device 320 by bending the flexible display device 320 forward, that is, by bending the edges of the flexible display device 320 towards the user, the detection module of the object control apparatus may detect the deformation of the flexible display device 320. Additionally, the control module may generate feature information from the deformation information regarding the detected deformation. For example, the control module may generate the feature information denoting that the deformation of the flexible display device 320 is performed in a ‘forward’ direction by bending the edges of the flexible display device 320 towards the user.

The control module may generate pattern information 330 matching the feature information by referring to the storage module, and may control the pointer or the object based on the pattern information 330.

Referring to FIG. 4, when the user deforms the flexible display device 420 by bending the flexible display device 420 backwards, that is, by bending the edges of the flexible display device 420 away from the user, the detection module of the object control apparatus may detect the deformation of the flexible display device 420. Additionally, the control module may generate feature information from the deformation information regarding the detected deformation. For example, the control module may generate the feature information denoting that the deformation of the flexible display device 420 is performed in a ‘backward’ direction by bending the edges of the flexible display device 420 away the user.

The control module may generate pattern information 430 matching the feature information by referring to the storage module, and may control the pointer or the object based on the generated pattern information 430.

The control module may generate information regarding the quantity of deformation axes, among the feature information related to deformation of the flexible display device, from the deformation information detected by the detection module. For example, the control module may generate the information regarding the quantity of deformation axes, from the deformation information regarding the deformation coordinate, the deformation force, and the like.

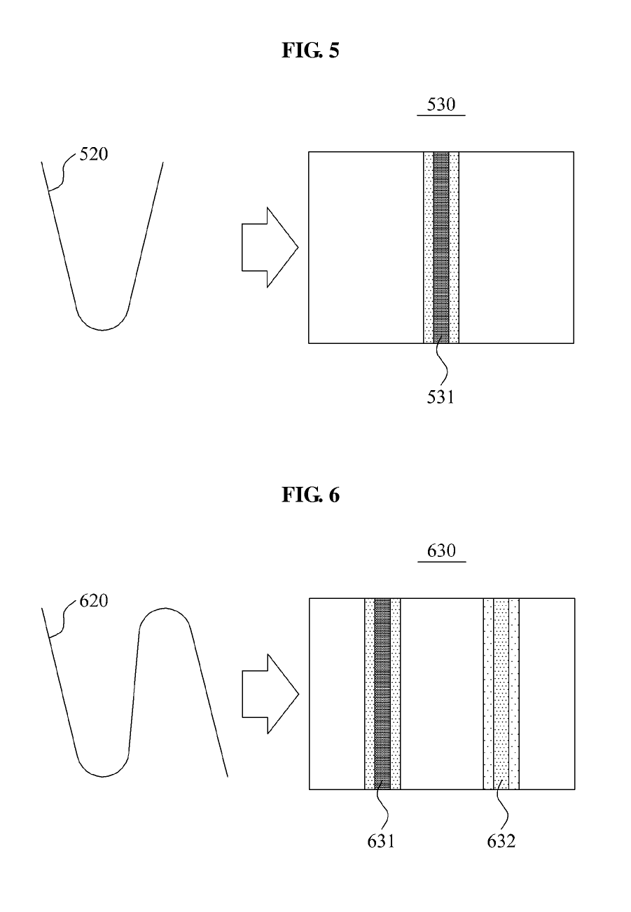

Referring to FIG. 5, when the user deforms a flexible display device 520 by bending the flexible display device 520 backwards, the control module of the object control apparatus may generate, from the deformation information, feature information denoting that the quantity of the deformation axes of the flexible display device 520 is ‘1.’ Also, the control module may generate pattern information 530 matching the feature information, by referring to the storage module.

Referring to FIG. 6, when the user bends one portion of a flexible display device 620 forward and the other portion of the flexible display device 620 backwards, the control module of the object control apparatus may generate, from the deformation information, feature information denoting that the flexible display device 620 is deformed at two deformation axes 631 and 632. Also, the control module may generate pattern information 630 matching the feature information by referring to the storage module.

Depending on embodiments, the control module may generate further feature information denoting that the flexible display device 620 is bent backwards with respect to a first deformation axis 631. The control module may generate still further feature information denoting that the flexible display device 620 is bent forward with respect to a second deformation axis 632.

The control module may generate information on the curvature of the deformation axis as the feature information regarding the deformation of the flexible display device, from the deformation information detected by the detection module. For example, the deformation information may include the deformation coordinate value, the deformation force, and the like of the flexible display device.

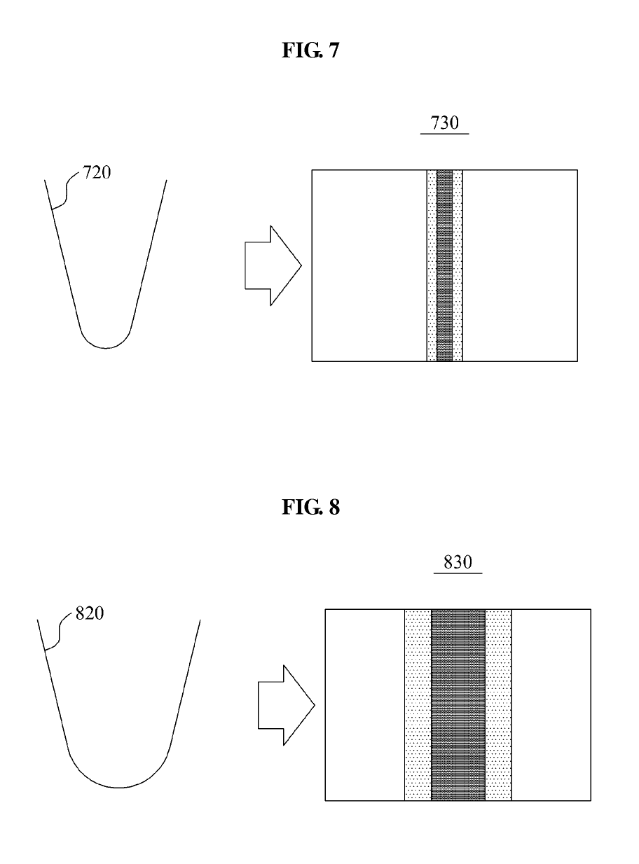

Referring to FIG. 7, when the user deforms a flexible display device 720 by bending the flexible display device 720 backwards with a greater force than a reference force, the control module may generate feature information regarding the degree of bending, that is, the curvature of the flexible display device 720 from the detected deformation information. For example, the feature information may denote that the curvature is about 50 on an arbitrary scale of 1 to 100. In addition, the control module may generate pattern information 730 matching the feature information by referring to the storage information.

Referring to FIG. 8, when the user deforms a flexible display device 820 by bending the flexible display device 820 backwards with a smaller force than the reference force, the control module may generate feature information regarding the degree of bending, that is, the curvature of the flexible display device 820 from the detected deformation information. For example, the feature information may denote that the curvature is about 10 on the arbitrary scale of 1 to 100. In addition, the control module may generate pattern information 830 matching the feature information by referring to the storage information.

Therefore, when the flexible display device 720 or 820 is merely bent backwards, the control module may control the object or the pointer according to the degree of bending, that is, the degree of curvature of the flexible display device 720 or 820.

For example, in a state where the operation of bending the flexible display device 720 or 820 backwards matches an execution operation for enlarging a selected object, the control module may enlarge the selected object by a greater degree when the curvature is about 50 than when the curvature is about 10.

The control module may generate information on the position of the deformation axis as the feature information related to the deformation of the flexible display device, from the deformation information detected by the detection module. For example, the deformation information may include the deformation coordinate value, the deformation force, and the like of the flexible display device.

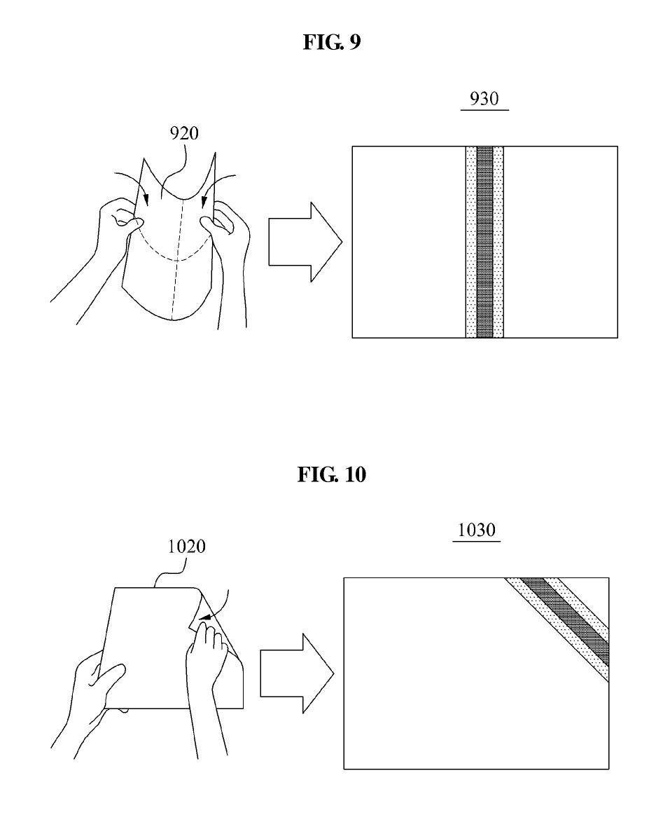

Referring to FIG. 9, when the user bends a flexible display device 920 backwards in a direction parallel to a vertical axis, the control module may generate feature information denoting that the flexible display device 920 is bent backwards parallel to the vertical axis, from the detected deformation information. Also, the control module may generate pattern information 930 matching the feature information by referring to the storage module.

Referring to FIG. 10, when the user bends a corner of a flexible display device 1020 backwards, the control module of the object control apparatus may generate feature information denoting that the corner of the flexible display device 1020 is bent backwards, from the detected deformation information. Also, the control module may generate pattern information 1030 by referring to the storage module.

The control module of the object control apparatus may generate information on the movement of the deformation axis as the feature information related to the deformation of the flexible display device, from the deformation information detected by the detection module. For example, the deformation information may include the deformation coordinate value, the deformation force, and the like of the flexible display device.

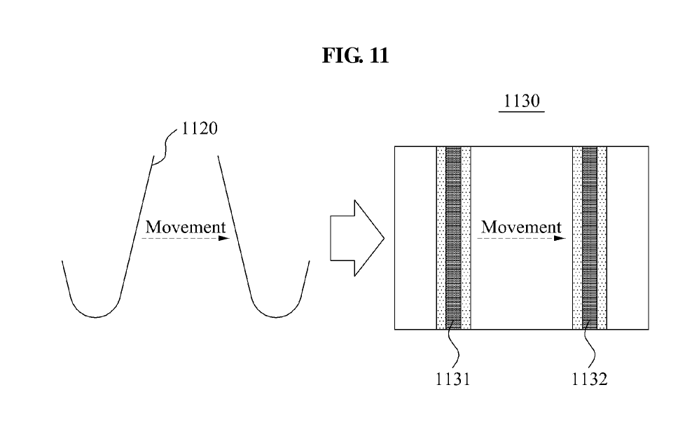

Referring to FIG. 11, when the user moves a bent portion of a flexible display device 1120 being bent backwards, the control module may generate feature information denoting that the bent portion is moving in the flexible display device 1120 in a bent state. Also, the control module may generate pattern information 1130 matching the feature information by referring to the storage module.

For example, after the user generates a first deformation axis 1131 by bending the flexible display device 1120 backwards, when the user moves the bent portion of the flexible display device 1120, the control module may generate, from the deformation information, feature information denoting that the bent portion, that is, the deformation axis moves from the first deformation axis 1131 to a second deformation axis 1132.

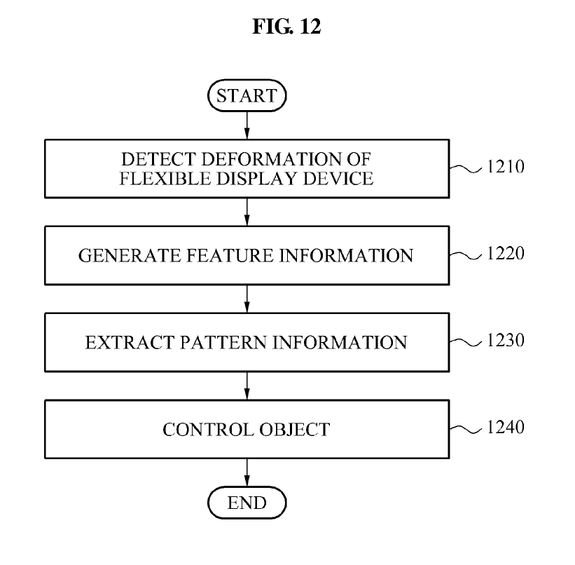

FIG. 12 illustrates a flowchart showing an object control method according to example embodiments.

Referring to FIG. 12, the object control method detects deformation of the flexible display device in operation 1210.

The user may input a predetermined input signal for controlling the pointer or the object, by deforming the flexible display device. For example, the user may deform the flexible display device by folding, bending, or rolling the flexible display device in a predetermined direction. At this time, the object control method may detect the deformation of the flexible display device.

The flexible display device according to the example embodiments may include a plurality of strain gauges arranged in the form of a grid. The plurality of strain gauges may include any one of thin metal film strain gauges, semiconductor strain gauges, and optical strain gauges.

The object control method may generate feature information regarding deformation on the flexible display device from deformation information regarding the detected deformation, in operation 1220. Here, the deformation information may include information on at least one of a deformation position, a deformation direction, and a deformation force of the flexible display device. Depending on embodiments, the deformation position may be indicated by a planar coordinate value with respect to a planar surface of the flexible display device.

That is, according to the object control method in accordance with the example embodiments, the feature information regarding the deformation direction, the quantity of deformation axes, the curvature of the deformation axes, the position of the deformation axes, and the movement of the deformation axes may be generated from the deformation information regarding the deformation position, direction, and force of the flexible display device.

For example, when the user deforms the flexible display device by folding the flexible display device inward, the object control method may generate feature information denoting a least one feature of the deformation of the flexible display device, from deformation information regarding detected deformation. In this case, the deformation information may include ‘middle’ as the deformation position, ‘inward’ as the deformation direction, ‘10’ as the deformation force. The feature information may include ‘inward’ as the deformation direction, ‘1’ as the quantity of the deformation axes from the deformation position, ‘5’ as the curvature of the deformation from the deformation force, ‘vertically middle’ as the position of the deformation axis from the deformation position, ‘none’ as the movement of the deformation axis.

In operation 1230, the object control method may extract pattern information matching the generated feature information, by referring to a first table. The table may store the feature information regarding the deformation of the flexible display device, and the pattern information regarding deformation patterns of the flexible display device, the deformation information matching the feature information.

The first table according to example embodiments may store the feature information and the pattern information. Here, the feature information and the pattern information may match each other.

The feature information may be related to deformation of the flexible display device.

The feature information may include at least one of the deformation direction, the quantity of the deformation axes, the curvature of the deformation axes, the position of the deformation axes, and the movement of the deformation axes, which are related to the deformation of the flexible display device.

In operation 1240, the object control method may control at least one of the pointer and the object based on the extracted pattern information.

According to the example embodiments, the object control method may process execution operations related to at least one of the pointer and the object, with reference to a second table. The second table stores the pattern information and the execution operations matching the pattern information.

For example, out of at least one pattern regarding the deformation of the flexible display device, a first pattern may match an execution operation for enlarging the object. Accordingly, when the deformation of the flexible display device performed by the user has the first pattern, the object control method may enlarge the object.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction.

Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. Any one or more of the software modules described herein may be executed by a dedicated processor unique to that unit or by a processor common to one or more of the modules. The described methods may be executed on a general purpose computer or processor or may be executed on a particular machine such as the apparatus for controlling an object described herein.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. An apparatus for controlling an object, the apparatus comprising:
a detection module to detect deformation of a flexible display device;
a storage module to store a first table including feature information regarding deformation of the flexible display device and pattern information regarding deformation patterns of the flexible display device; and
a control module to generate selected feature information from the feature information stored in the first table based on deformation information of the detected deformation, to extract selected pattern information corresponding to the generated feature information from the pattern information stored in the first table, and to control at least one of a pointer and an object based on the extracted pattern information.

2. The apparatus of claim 1, wherein the deformation information comprises information on at least one of a deformation position, a deformation direction, and a deformation force, each of which are related to the deformation of the flexible display device.

3. The apparatus of claim 1, wherein the feature information comprises information on at least one of a deformation direction, a quantity of deformation axes, a curvature of the deformation axis, a position of the deformation axis, a movement of the deformation axis, each of which are related to the deformation of the flexible display device.

4. The apparatus of claim 1, wherein
the storage module further stores a second table including the pattern information, and an execution operation related to at least one of the pointer and the object matching the pattern information, and
the control module processes the execution operation matching the extracted pattern information by referring to the second table.

5. The apparatus of claim 1, wherein the flexible display device comprises a plurality of strain gauges in the form of a grid.

6. The apparatus of claim 5, wherein the plurality of strain gauges comprise any one of thin metal film strain gauges, semiconductor strain gauges, and optical strain gauges.

7. The apparatus of claim 1, wherein in the first table stored in the storage module, the pattern information matches the feature information.

8. A method for controlling an object, the method comprising:
detecting deformation of a flexible display device;
generating selected feature information from stored feature information regarding deformation of the flexible display device, based on deformation information of the detected deformation;
extracting selected pattern information corresponding to the generated feature information, from stored pattern information regarding deformation patterns of the flexible display device; and
controlling, by way of a processor, at least one of a pointer and an object based on the extracted pattern information.

9. The method of claim 8, wherein the feature information comprises information on at least one of a deformation direction, a quantity of deformation axes, a curvature of the deformation axis, a position of the deformation axis, a movement of the deformation axis, each of which are related to the deformation of the flexible display device.

10. A non-transitory computer readable recording medium storing a program to cause a computer to implement the method of claim 8.

11. The method of claim 8, wherein the pointer and the object are each displayed by the display device.

12. A flexible display device comprising:
a processor;
a detection module to detect deformation of the flexible display device; and
a control module to generate an execution operation of the flexible display device in accordance with the deformation of the flexible display device detected by the detection module.

13. The flexible display device of claim 12, wherein the control module controls an operation of the flexible display device based on the generated execution operation.

14. The flexible display device of claim 13, wherein the controlled operation comprises controlling at least one of a pointer and an object displayed by the flexible display device.

15. The flexible display device of claim 13, further comprising:
a storage module to store a first table including pattern information regarding deformation patterns of the flexible display device,
wherein the control module generates feature information based on the deformation of the flexible display device detected by the detection module, extracts pattern information from the first table corresponding to the generated feature information, and controls the operation of the flexible display device based on the extracted pattern information.

16. The flexible display device of claim 14, further comprising:
a storage module to store a first table including pattern information regarding deformation patterns of the flexible display device,
wherein the control module generates feature information based on the deformation of the flexible display device detected by the detection module, extracts pattern information from the first table corresponding to the generated feature information, and controls the at least one of the pointer and the object based on the extracted pattern information.
